(19) United States
(12) Patent Application Publication
(10) Pub. No.: US 2008/0152510 A1
(43) Pub. Date: Jun. 26, 2008

(54) VALVE FOR CONTROLLING FLOW OF A PRIMARY FLUID

(75) Inventor: John Krumme, Woodside, CA (US)

Correspondence Address: KIRTON AND MCCONKIE, 60 EAST SOUTH TEMPLE,, SUITE 1800, SALT LAKE CITY, UT, 84111, US

(73) Assignee: Beta MicroPump Partners LLC, Menlo Park, CA (US)

(21) Appl. No.: 11/613,903

(22) Filed: Dec. 20, 2006

(51) Int. Cl. F04B 49/00; F16K 31/00

(52) U.S. Cl. 417/300; 137/508

(57) ABSTRACT

A valve for controlling flow of a primary fluid in a primary flow channel is defined in a valve region by a deformable membrane. The primary flow channel includes a core in the valve region, and a housing which defines a void outside the primary flow channel in the valve region thereof. The valve includes a device for driving a displacement fluid into or out of the void or both, to vary the pressure difference across the deformable membrane between the primary flow channel and the void, and so as to vary the space that is available between the deformable membrane of the primary flow channel and the core for the primary fluid to flow along the primary flow channel. A pump can include a valve as described above as a driver valve, together with an inlet valve and an outlet valve.

### BACKGROUND TO THE INVENTION

This invention relates to a valve for controlling flow of a primary fluid, and to a pump for controlling flow of a primary fluid which incorporates a valve.

The flow of fluids through conduits can be controlled using components such as pumps and valves. Pumps and valves can operate to control parameters such as flow rate; adjustment of relative flow rates of constituents in a mixture can be used to vary the composition of the mixture.

Accurate control of flow of a fluid can be important in many medical applications, for example in drug delivery and in the modulation of body fluid drainage. Devices in which flow control is important include pumps for dispensing drugs such as insulin and opiates, and hydrocephalus shunts for drainage of spinal fluids.

Accurate control over the flow of drugs and fluids in medical applications can help to minimise complications in the patient treatment, especially if controlled quantities of drugs can be supplied locally to an affected site. Accurate control can help to optimise efficacy of an administered drug. The use of controlled quantities can also help to minimise wastage of drugs, and therefore to minimise treatment costs. An implanted device for controlling flow of drugs can help to ensure compliance with prescribed drug administration regime by eliminating patient dependence on operation of the device.

Accurate and localised control of a drug can be facilitated by means of implanted control devices. U.S. Pat. No. 6,287,295 relates to an implantable device which relies on a semipermeable membrane to control the rate of drug delivery. However, once implanted, the rate of flow of drug through the membrane cannot readily be adjusted.

Electro-osmotic flow controllers apply a potential difference to liquid on opposite sides of a semi-permeable membrane made of a dielectric material. Provided that the liquid is able to yield a high zeta potential with respect to the porous dielectric material of the membrane, the application of the potential difference leads to transmission of charged species, possibly together with solvent (for example which solvates the charged species or as bulk solvent by viscous drag), through the membrane. This technology can be used to control the rate at which a liquid is supplied, for example under pressure which is generated by means of a pump. The technology, including amongst other things details of the materials which can be used for the membrane and as the liquid which is transmitted across the membrane, is discussed in detail in US-A-2002/189947. Subject matter disclosed in that document is incorporated in the specification of the present application by this reference.

### SUMMARY OF THE INVENTION

The present invention provides a valve for controlling flow of a primary fluid in a primary flow channel which is defined by a deformable membrane with a core within it. A displacement fluid can be driven against the deformable membrane to vary the pressure difference across it so as to vary the space that is available between the deformable membrane and the core for the primary fluid to flow along the primary flow channel.

Accordingly, in one aspect, the invention provides a valve for controlling flow of a primary fluid in a primary flow channel, comprising:

a. a primary flow channel which is defined in a valve region by a deformable membrane,
b. a core within the primary flow channel in the valve region thereof,
c. a housing which defines a void outside the primary flow channel in the valve region thereof,
d. a source of a displacement fluid, and
e. a device for driving the displacement fluid into or out of the void or both, to vary the pressure difference across the deformable membrane between the primary flow channel and the void, and so as to vary the space that is available between the deformable membrane of the primary flow channel and the core for the primary fluid to flow along the primary flow channel.

The valve of the invention can enable precise control over the rate of flow of the primary fluid in the primary flow channel. It can therefore enable the quantity of the primary fluid to be controlled.

Preferably, the deformable membrane is provided as a tube which is formed from the deformable material, which defines the primary flow channel in the valve region. Preferably, the core is provided within the tube. This can allow for the flow of the primary fluid within the deformable membrane around the entire periphery of the core.

Preferably, the void extends around the entire periphery of the primary flow channel. This can be appropriate when the deformable membrane is provided as a tube which is formed from the deformable material.

In a preferred arrangement, the primary flow channel is defined in the valve region by a rigid tube which has the deformable membrane of the primary flow channel overlying it and which contains a partition to prevent flow of the primary fluid along the rigid tube, the rigid tube having at least two openings in its wall positioned to provide a flow path for fluid in the valve region past the partition through a space defined by the external surface of the rigid tube and the deformable membrane. In this arrangement, the membrane is deformed outwardly to allow flow of the primary fluid. Such deformation can be controlled by displacement of the displacement fluid. In this arrangement, the valve tends towards a configuration in which it is closed against flow of the primary fluid as a result of the action of the resilient material of the membrane.

The rigid tube can have a series of openings in its wall arranged around the rigid tube on each side of the partition, for fluid to flow out of the rigid tube into the space defined between the outer wall of the tube and the inner wall of the deformable membrane. Preferably, the deformable membrane is provided as a tube in which the rigid tube is provided. Preferably, the void extends around the entire periphery of tubular deformable membrane.

In a preferred arrangement, the primary flow channel is defined in the valve region by a core which has a recess formed in its peripheral surface, and in which the recess has a recess inlet through which fluid flowing in the primary flow channel is received, and a recess outlet through which fluid can be discharged from the recess to flow along the primary flow channel, and in which the deformable membrane overlies the recess and can be deformed by action on it of the pressurised displacement fluid to conform to the recess so as to close it against flow of the fluid.

Preferably, the recess extends around the entire periphery of the core. Such a recess will have a generally annular configuration. The recess can be provided in one or more localised regions in the outer wall of the core. When the recess is provided at two or more localised regions, these can be at a common point along the length of the core. It can be preferred for some applications for the regions to be spaced apart uniformly around the core.

Preferably, the cross-sectional area of the recess, when viewed in the general direction of flow of the primary fluid from the recess inlet to the recess outlet, increases from a point at or close to the recess inlet towards the recess outlet. Preferably, the distance along the length of the recess from the recess inlet to the point at which the cross-sectional area of the recess is greatest (the “inlet distance”) is greater than the distance along the length of the recess from the point at which the cross-sectional area of the recess is greatest to the recess outlet (the “outlet distance”). Preferably, the ratio of the inlet distance to the outlet distance is at least about 2, more preferably at least about 3.

The primary flow conduit can be defined outside the valve region by a core which has at least one groove formed in its peripheral surface and by an overlying membrane. The core will generally have a plurality of grooves formed in its peripheral surface. The grooves can extend straight along the axis of the core. The grooves can extend helically around the core.

Preferably, the overlying membrane which defines the primary flow channel outside the valve region is continuous with the deformable membrane which defines the primary flow channel in the valve region.

The shape of the core when it is viewed in cross-section can be selected according to the requirements of a particular application. Examples of suitable cross-sectional shapes include rounded shapes and shapes which are polygonal (regular and irregular) with three, four, five, six, seven, eight or more sides. Rounded shapes are particularly preferred, especially circular.

The driver device can comprise an electro-osmotic device. Electro-osmotic devices apply a potential difference to liquid on opposite sides of a semi-permeable membrane made of a dielectric material. Provided that the liquid is able to yield a high zeta potential with respect to the porous dielectric material of the membrane, the application of the potential difference leads to transmission of charged species, possibly together with solvent (for example which solvates the charged species or as bulk solvent by viscous drag), through the membrane. This technology can be used to control the rate at which a liquid is supplied, for example under pressure which is generated by means of a pump. Examples of materials which can be used for the membrane include silicon dioxide (silica), and certain glasses and polyesters. Examples of fluids which can be transmitted through the membrane can include solutions of ionic species. An example of such a fluid is a saline solution. The technology, including amongst other things details of the materials which can be used for the membrane and as the liquid which is transmitted across the membrane, is discussed in detail in US-A-2002/189947. Subject matter disclosed in that document is incorporated in the specification of the present application by this reference.

WO-2005/021968 discloses a valve which makes use of an electro-osmotic device to control flow of a primary fluid in a primary flow channel. The electro-osmotic device drives a valve fluid to cause a valve member to be displaced between open and closed positions. The capacity for flow of the primary fluid in the primary flow channel is greater when the valve member is in the open position than when it is in the closed position. The valve can be incorporated into a pump when combined with inlet and outlet valves. The features of relevant valves and pumps that are disclosed in WO-2005/021968 can therefore be incorporated into the delivery device of the present invention and such disclosed subject matter is incorporated in the specification of the present application by this reference.

The electro-osmotic device can act on the displacement fluid directly when the displacement fluid is able to yield a high zeta potential with respect to the porous dielectric material of the semi-permeable membrane. The application of the potential difference can then lead to transmission of the displacement fluid through the membrane.

Factors which might affect the choice of the displacement fluid can include the nature of the device by which it is driven into the chamber. For example, if the displacement fluid is required to pass through the porous dielectric material of the membrane of an electro-osmotic device, it will be required to yield a high zeta potential with respect to the porous dielectric material of the membrane so that it can be transmitted through the membrane on application of a potential difference. The choice of a displacement fluid might also be affected by applicable safety requirements, for example which apply because the delivery device is to be used for a medical application, especially if it is to be implanted in a patient.

The displacement fluid can be a liquid or a gas. It will generally be a liquid when it is required to pass through the porous dielectric material of the membrane of an electro-osmotic device. It will generally then be preferred to include a source reservoir for that liquid. A source reservoir need not be included for certain displacement fluids, for example when the displacement fluid is an ambient fluid to which the delivery device is exposed when in use. For example, when the delivery device is intended to be exposed to atmospheric air, the air can be used as the displacement fluid. When the delivery device is intended to be exposed to a body fluid, especially when the delivery device is implanted in a patient, that body fluid can be used as the displacement fluid. The driver device can then communicate with an opening which is exposed to the ambient fluid to which the exterior of the delivery device is exposed. For example, when the driver device is located at one end of the housing, the opening for ambient fluid can be provided at that end of the housing.

The material which is used for the resilient membrane in the valve of the invention should be selected so that it is not affected adversely on contact with fluids such as the displacement fluid and the primary fluid. It should be capable of resilient deformation during use so that, within an elastic range, deformation is recovered, at least to a significant degree (for example at least about 90% recovered, ideally at least about 97% recovered). Examples of suitable materials might include silicone rubbers, urethane rubbers, ethylene-propylene rubbers and so on.

In another aspect, the invention provides a pump for controlling flow of a primary fluid in a primary flow channel, which comprises:

a. a primary flow channel which is defined in a valve region by a deformable wall,
b. a driver valve comprising:
i. a core within the primary flow channel in the valve region thereof,
ii. a housing which defines a void outside the primary flow channel in the valve region thereof,
iii. a source of a displacement fluid, and
iv. a device for driving the working fluid into or out of the void or both, to vary the pressure difference across the deformable wall between the primary flow channel and the void, and so as to vary the space that is available between the deformable wall of the primary flow channel and the core for the primary fluid to flow along the primary flow channel,
   c. an inlet valve located upstream of the driver valve, for controlling flow of primary fluid into the primary flow channel where it is acted on by the driver valve, and
   d. an outlet valve located downstream of the driver valve, for controlling release of primary fluid from the primary flow channel where it is acted on by the driver valve.

The pump of the invention can make use of features of the valve which is discussed above.

It can be preferred for at least one of the inlet valve and the outlet valve to comprise an electro-osmotic device.

It can be preferred for at least one of the inlet valve and the outlet valve to comprise a valve as discussed above.

The valve of the invention can be incorporated in a device for delivery of a primary fluid. Such a device can include a reservoir for the primary fluid. The flow of the primary fluid from the reservoir can be controlled by means of a valve in accordance with the invention. The volume of the reservoir for the primary fluid might be at least about 10 μl. The volume of the reservoir for the primary fluid might be at least about 100 μl. The volume of the reservoir for the primary fluid might be at least about 250 μm. The volume of the reservoir for the primary fluid might be at least about 500 μl. The volume of the reservoir might be not more than about 5000 μl. The volume of the reservoir might be not more than about 2000 μl. The volume of the reservoir might be not more than about 1000 μl.

The device will generally require that the primary fluid is driven from the reservoir. It can be driven from the reservoir by means of a pump which, when actuated, causes the primary fluid to be delivered. It can be driven from the reservoir by means of a biasing device such as a sprung piston, or a resiliently deformable membrane which defines the wall of the reservoir. It can be particularly preferred that the device includes a pump which comprises a driver valve which is in accordance with the invention, together with an inlet valve and an outlet valve.

Some or all of the valve or pump components of a fluid delivery device can be provided in a base assembly for the reservoir. The reservoir for the primary fluid can then be provided on one face of the base assembly, for example by a membrane which is attached to the base assembly on that face. It can be preferred for the reservoir to be capable of being refilled, for example by the provision of a sealable septum, of a kind which is generally known.

A fluid delivery device according to the invention can include a valve according to the invention, including a source of a displacement fluid and a device for driving the displacement fluid. When the device for driving the displacement fluid requires a source of electric power for its operation, the fluid delivery device can include the power source, for example in the form of a battery.

Preferably, the delivery device includes an outlet valve to control flow of the primary fluid from the device. The outlet valve should allow flow of the primary fluid out of the device and restrict (preferably, prevent) flow of fluid in the reverse direction. Suitable constructions of outlet valve for restricting flow of fluid to a single flow direction are known.

A preferred outlet valve can incorporate an electro-osmotic device. A suitable electro-osmotic device can include a flow channel for the primary fluid which is compressible, which is acted on by a working fluid after the working fluid has passed through a membrane of a porous dielectric material. Constructions of suitable outlet valves are disclosed in WO-2005/021968. The outlet valve can be provided in a disk which is located at one end of the delivery device of the invention. When the outlet valve includes a flow channel for the primary fluid, the direction of flow of the primary fluid can be through the disk along its axis, with the working fluid acting in the plane of the disk to compress the flow channel.

### BRIEF DESCRIPTION OF THE DRAWINGS

FIG. 1 is an isometric view, partially in section, through a fluid delivery device according to the invention.

FIG. 2 is a sectional elevation through the device which is shown in FIG. 1.

FIG. 3 is a cross-section through a first embodiment of a valve according to the invention, which can be used as the driver valve in the fluid delivery device which is shown in FIGS. 1 and 2.

FIG. 4 is an isometric view of parts of the inlet section and of the valve region of the core of the valve shown in FIG. 3.

FIG. 5 is a cross-section through a second embodiment of a valve according to the invention.

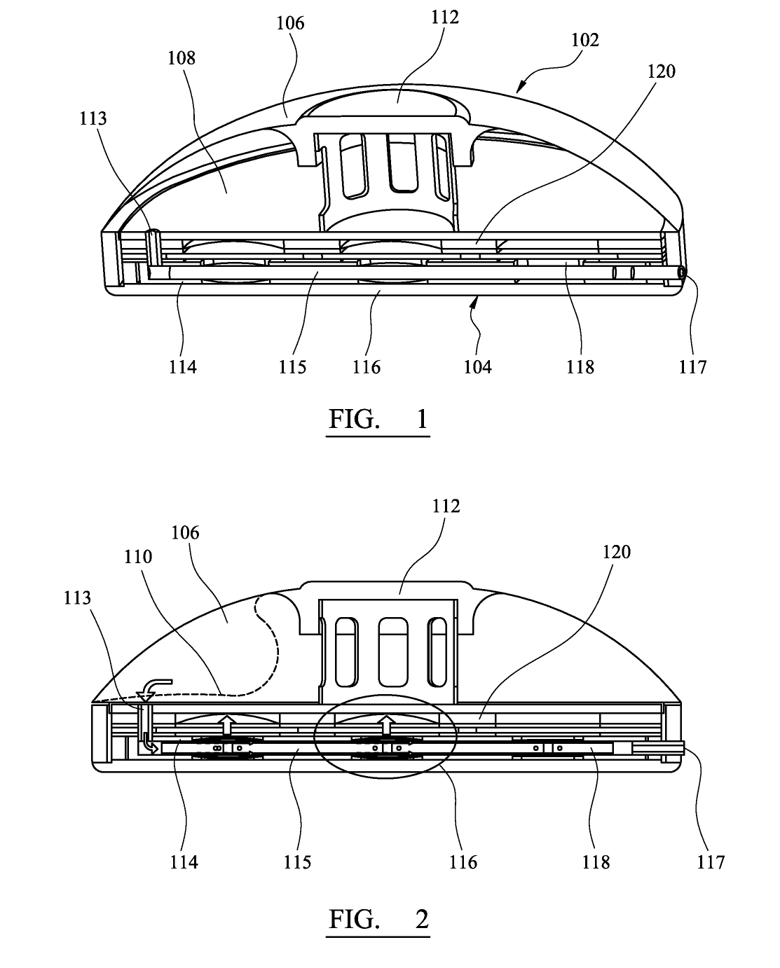

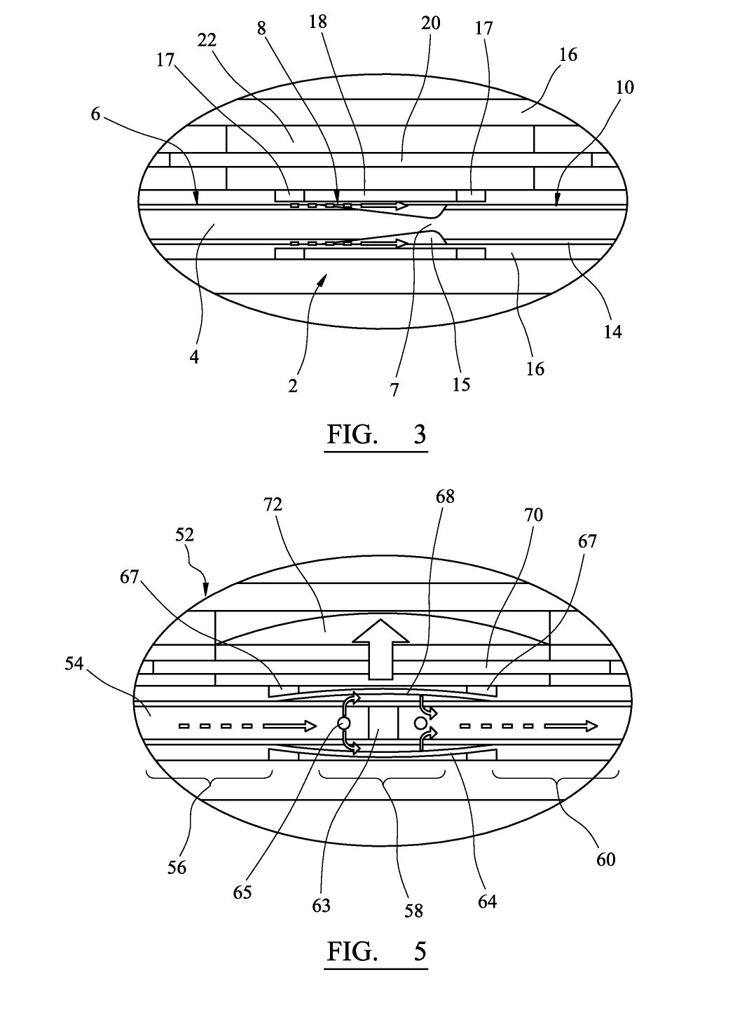

Referring to the drawings, FIGS. 1 and 2 show a device 102 which can be used to deliver a primary fluid in controlled quantities. The device can be used to delivery a drug to a patient. The device is particularly well suited to implantation in a patient for controlled delivery of a drug over a prolonged period.

The device comprises a base 104 and a bladder 106 which is fixed to the base around its periphery to define a reservoir 108 for the primary fluid. The bladder is made from a flexible material which is capable of resilient deformation so that the volume of the reservoir can change by reversible collapse (as shown in dotted outline 10) and expansion. The bladder can be made from a resilient material such as a silicone rubber.

The bladder has a central resealable septum 112 fitted to it which can be penetrated by a needle for refilling of the reservoir.

The base 104 of the device contains control components for controlling the discharge of primary fluid from the reservoir. The base has an inlet 113 for the primary fluid to enter from the reservoir. The base includes a passage 115 for the primary fluid to flow through it, from the inlet to an outlet 117. These include a pump which is made up of an inlet valve 114, a driver valve 116 and an outlet valve 118. The driver valve has a void around it in which a quantity of the primary fluid can be held. Constructions of valve which can be used as the driver valve in the device of the invention are described in more detail below with reference to FIGS. 3 and 5. The constructions of the inlet valve and the outlet valve can be the same as the construction of the driver valve or can be different. In particular, it is envisaged that the inlet valve or the outlet valve or each of them need not be constructed so that a quantity of a primary fluid can be retained in an associated void.

The base includes a power source 120 in the form of a battery which can be used to power the valves as they operate between their open and closed positions.

The sequence of operation of the valves during discharge of primary fluid from the device involves:

### 1. Open inlet valve 114.

### 2. Open driver valve 116 to withdraw primary fluid from the reservoir into a holding void which is associated with the driver valve.

### 3. Close inlet valve 114.

### 4. Open outlet valve 118.

### 5. Close driver valve 116 to expel the primary fluid from the holding void which is associated with the driver valve.

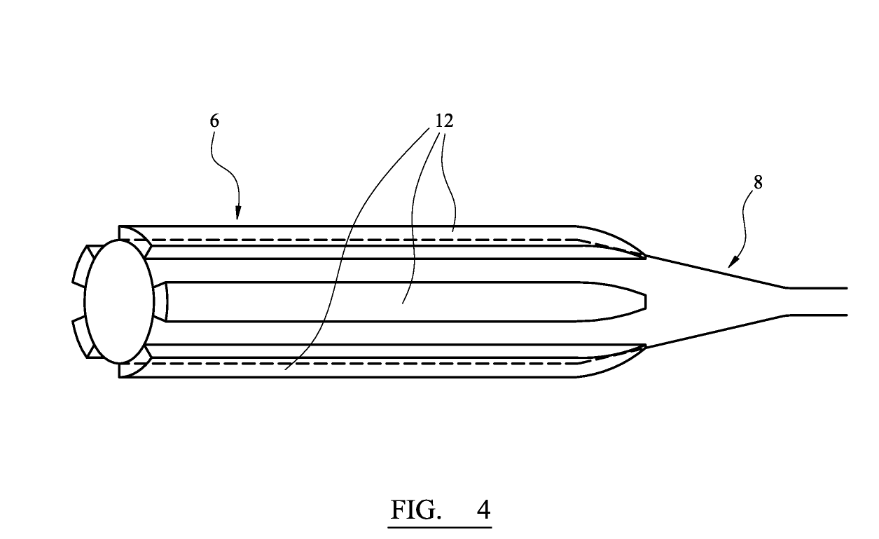

FIG. 3 shows a valve 2 which can be used as the driver valve 116, and possibly also as the inlet valve or the outlet valve or each of them, in a device as shown in FIGS. 1 and 2. The valve 2 comprises a core 4 in the form of a stainless steel rod. The diameter of the core is 2 mm. The core comprises an inlet section 6, a valve region 8 and an outlet section 10. The rod has a plurality of grooves 12 extending along its length in each of the inlet and outlet sections, as shown in FIG. 4.

The valve includes a tube 14 of an elastomeric material which is a tight it around the core to close the grooves along their lengths so that the grooves become channels with a closed cross-section. The tube is formed from a silicone rubber, with a wall thickness of about 0.2 mm.

In the valve region 8, the core 4 has an annular recess 15 formed in it. The cross-sectional area of the core decreases through the valve region from the inlet section 6 towards the outlet section to a point 7 at which the cross-sectional area of the core is at a minimum, and then increases towards the outlet section. The ratio of the length of the portion of the recess from the inlet section to the point of minimum cross-sectional area to the length of the portion from the point of minimum cross-sectional area to the outlet section is about 7. The core 4 and the surrounding tube 14 are located within a housing 16. In the inlet and outlet sections 6, 10, the core and the surrounding tube are a tight fit in the housing so that the housing supports the tube against outward expansion due to the pressure of fluid within the grooves 12 in the core.

Tight annular seals 17 are provided around the surrounding tube 14 between the tube and the housing 16 at opposite ends of the valve region, defining a void 18 surrounding the core in the valve region between the inlet and outlet sections.

On one side of the core, the void 18 is in fluid communication with an electro-osmotic device. The device comprises a laminate 20 of a layer of a porous dielectric material which consists of a silica, sandwiched between a pair of electrodes.

The laminate separates the void 18 from a reservoir 22 for a displacement fluid.

In use, the primary fluid flows along the grooves 12 in the inlet section 6 of the core 4. The primary fluid is able to flow into the recess 15 which surrounds the core in the valve region 8, while there is a space between the core and the internal surface of the surrounding tube 14 throughout the length of the valve region. The primary fluid is then able to flow from the valve region and out of the valve through grooves in the outlet section 10 of the core. However, when the surrounding tube contacts the core in the valve region continuously around the periphery of the core, the tube presents an obstacle to flow of the primary fluid so that the valve becomes closed.

The space between the core 4 in the valve region 8 and the surrounding tube 14 is controlled by movement of displacement fluid between the reservoir 22 and the void 18. Movement of the displacement fluid from the reservoir 22 into the void 18 causes the tube 14 to be forced towards the core 4, resulting in a reduction in the distance between the core and the tube, and ultimately to contact between the tube and the core continuously around the periphery of the core so that the path for flow of the primary fluid through the valve becomes closed.

The shape of the core 4 in the valve region 8, involving a gradual reduction in diameter along its length from the inlet section 6 toward a point 7 where the diameter is at a minimum, as discussed above, means that the tube 14 tends to contact the core first at the end of the valve region 8 which is closest to the inlet section 6, and then progressively to contact the core along the length of the valve region towards the outlet section 10. This results in progressive expulsion of the primary fluid from the valve region of the pump as a result of pumping displacement fluid from the reservoir 22 into the void 18 around the tube 14 in the valve region of the device.

FIG. 5 shows a valve 52 which can be used as the driver valve 116, and possibly also as the inlet valve or the outlet valve or each of them, in a device as shown in FIGS. 1 and 2. The valve 52 comprises a core 54 in the form of a stainless steel tube. The external diameter of the tube is 2 mm. The core comprises an inlet section 56, a valve region 58 and an outlet section 60.

The valve includes a surrounding tube 64 of an elastomeric material which is a tight it around the core in the valve region 58 only. The surrounding tube 64 is formed from a silicone rubber, with a wall thickness of about 0.2 mm.

The core contains a wall 63 in the valve region. The wall prevents flow of primary fluid through the core.

The core 54 has a plurality of openings 65 formed in it in the valve region 58, through which primary fluid can flow between the tubular cavity within the core and a space around the core. Some of the openings are on the inlet side of the wall 63 and some of the openings are on the outlet side of the wall 63 so that, when there is a space around the core in the valve region between the core and the surrounding tube 64, the openings provide a path for fluid to flow between the inlet side and the outlet side of the wall 63 in the valve region. Preferably, the openings are provided as an array of perforations which are spaced apart along the length of the core in the valve region and around its periphery.

The core 54 and the surrounding tube 64 are located within a housing 66. Tight annular seals 67 are provided around the surrounding tube 64 between the tube and the housing 66 at opposite ends of the valve region, defining a void 68 surrounding the core in the valve region between the inlet and outlet sections, which is in fluid communication with the tubular cavity within the core through the openings 65. The seals are such that primary fluid in the void cannot leave the void other than through the openings 65 in the wall of the core 64.

On one side of the core, the void 68 is defined by an electro-osmotic device. The device comprises a laminate 70 of a layer of a porous dielectric material which consists of a silica, sandwiched between a pair of electrodes.

The laminate separates the void 68 from a reservoir 72 for a displacement fluid.

In use, the primary fluid flows along the inlet section 56 of the core 54. The primary fluid is able to flow through openings 65 in the core on the inlet side of the wall 63 into the void 68 which surrounds the core in the valve region 58, while there is a space between the core and the internal surface of the surrounding tube 64. The primary fluid is then able to flow from the void 68 out of the valve region through the openings 65 in the core on the outlet side of the wall 63 into the internal cavity in the core 54. However, when the surrounding tube contacts the core in the valve region continuously around the periphery of the core, the tube presents an obstacle to flow of the primary fluid so that the valve becomes closed.

1. A valve for controlling flow of a primary fluid in a primary flow channel, comprising:
a. a primary flow channel which is defined in a valve region by a deformable membrane,
b. a core within the primary flow channel in the valve region thereof,
c. a housing which defines a void outside the primary flow channel in the valve region thereof,
d. a source of a displacement fluid, and
e. a device for driving the displacement fluid into or out of the void or both, to vary the pressure difference across the deformable membrane between the primary flow channel and the void, and so as to vary the space that is available between the deformable membrane of the primary flow channel and the core for the primary fluid to flow along the primary flow channel.

2. A valve as claimed in claim 1, in which the primary flow channel is defined in the valve region by a tube formed from a deformable material.

3. A valve as claimed in claim 1, in which the void extends around the entire periphery of the primary flow channel.

4. A valve as claimed in claim 1, in which the primary flow channel is defined in the valve region by a rigid tube which has the deformable membrane of the primary flow channel overlying it and which contains a partition to prevent flow of the primary fluid along the rigid tube, the rigid tube having at least two openings in its wall positioned to provide a flow path for fluid in the valve region past the partition through a space defined by the external surface of the rigid tube and the deformable membrane.

5. A valve as claimed in claim 4, in which the void extends around the entire periphery of the primary flow channel, and in which the rigid tube has a series of openings in its wall arranged around the rigid tube on each side of the partition.

6. A valve as claimed in claim 1, in which the primary flow channel is defined in the valve region by a core which has a recess formed in its peripheral surface, and in which the recess has a recess inlet through which fluid flowing in the primary flow channel is received, and a recess outlet through which fluid can be discharged from the recess to flow along the primary flow channel, and in which the deformable membrane overlies the recess and can be deformed by action on it of the pressurised displacement fluid to conform to the recess so as to close it against flow of the fluid.

7. A valve as claimed in claim 6, in which the recess extends around the entire periphery of the core.

8. A valve as claimed in claim 6, in which the cross-sectional area of the recess, when viewed in the general direction of flow of the primary fluid from the recess inlet to the recess outlet, increases from a point at or close to the recess inlet towards the recess outlet.

9. A valve as claimed in claim 6, in which the primary flow channel is defined outside the valve region by a core which has at least one groove formed in its peripheral surface and by an overlying membrane.

10. A valve as claimed in claim 9, in which the core has a plurality of grooves formed in its peripheral surface.

11. A valve as claimed in claim 9, in which the overlying membrane which defines the primary flow channel outside the valve region is continuous with the deformable membrane which defines the primary flow channel in the valve region.

12. A valve as claimed in claim 6, in which the core is circular when viewed in cross-section.

13. A valve as claimed in claim 1, in which the driver device comprises an electro-osmotic device.

14. A pump for controlling flow of a primary fluid in a primary flow channel, which comprises:
a. a primary flow channel which is defined in a valve region by a deformable wall,
b. a driver valve comprising:
i. a core within the primary flow channel in the valve region thereof,
ii. a housing which defines a void outside the primary flow channel in the valve region thereof,
iii. a source of a displacement fluid, and
iv. a device for driving the working fluid into or out of the void or both, to vary the pressure difference across the deformable wall between the primary flow channel and the void, and so as to vary the space that is available between the deformable wall of the primary flow channel and the core for the primary fluid to flow along the primary flow channel,
c. an inlet valve located upstream of the driver valve, for controlling flow of primary fluid into the primary flow channel where it is acted on by the driver valve, and
d. an outlet valve located downstream of the driver valve, for controlling release of primary fluid from the primary flow channel where it is acted on by the driver valve.

15. A pump as claimed in claim 14, in which at least one of the inlet valve and the outlet valve comprises an electro-osmotic device.

16. A pump as claimed in claim 14, in which at least one of the inlet valve and the outlet valve comprises a valve as claimed in claim 1.
